(19) United States
(12) Patent Application Publication
(10) Pub. No.: US 2023/0384954 A1
(43) Pub. Date: Nov. 30, 2023

(54) STORAGE DEVICE AND DATA PROCESSING METHOD

(71) Applicant: Samsung Electronics Co., Ltd, Suwon-si (KR)

(72) Inventors: Min-Ho KIM, Suwon-si (KR); Dongouk MOON, Suwon-SI (KR); Soo-Young Ji, Suwon-si (KR); Sang-Hwa Jin, Suwon-si (KR)

(73) Assignee: Samsung Electronics Co., Ltd, Suwon-si (KR)

(21) Appl. No.: 18/062,268

(22) Filed: Dec. 6, 2022

(30) Foreign Application Priority Data
May 30, 2022 (KR) 10-2022-0066362

(51) Int. Cl. G06F 3/06; H04L 9/08

(52) U.S. Cl. CPC G06F 3/0623; G06F 3/0629; G06F 3/0679; H04L 9/0861

(57) ABSTRACT

A storage device may include a memory, and a storage controller that is configured to generate a hash value, scramble input data with the hash value to generate scrambled data, and store the scrambled data and hash value in association with each other in a memory.

### CROSS-REFERENCE TO RELATED APPLICATION

This application claims priority to and the benefit of Korean Patent Application No. 10-2022-0066362 filed in the Korean Intellectual Property Office on May 30, 2022, the entire contents of which are incorporated herein by reference.

### BACKGROUND

### 1. Field

The disclosure relates to storage devices and data processing methods.

### 2. Description of the Related Art

A storage device is used as a data storage medium of various electronic devices. The storage device may store contents data such as still images, video images, and audio contents created or edited in various electronic devices.

Recently, content that appears to have been captured from a human subject, but is actually manipulated by a computer without a subject, is being created. Such manipulated content may be created or edited to deceive or embarrass viewers. Since the manipulated content may be stored in the storage device or the contents data stored in the storage device may be replaced with the manipulated content and stored, there is a risk of distributing the manipulated content (which may be, for example, malicious or deceptive). Accordingly, there is a demand for securing the contents data stored in the storage device.

### SUMMARY

Some example embodiments are to provide data storage devices for reducing or preventing falsification of stored data, and data processing methods.

Some example embodiments are to provide storage devices for detecting falsified data, and data processing methods.

According to some aspects of the inventive concepts, there is provided a storage device according to some example embodiments for solving such a technical problem includes a memory; and a storage controller configured to generate a hash value, generate scrambled data by scrambling input data with the hash value, and store the scrambled data and the hash value in association with each other in the memory.

In some example embodiments, the storage controller may be configured to generate the hash value by applying a hash algorithm to an output value or input data of a random number generator.

In some example embodiments, the storage controller may be configured to generate scrambled data by performing XOR operation on the input data and the hash value.

In some example embodiments, the storage controller may be configured to apply a hash algorithm to the hash value at least once to generate at least one additional hash value, and generate the scrambled data by performing XOR operation on the input data, the hash value, and the at least one additional hash value.

In some example embodiments, the memory may include a plurality of nonvolatile memories, the storage controller may be configured to encode the scrambled data and the hash value into a plurality of pieces of encoded data, and distribute and store the plurality of pieces of the encoded data in the plurality of nonvolatile memories, and each of the plurality of pieces of encoded data may include a part of the scrambled data and a part of the hash value.

In some example embodiments, each of the plurality of nonvolatile memories may include a plurality of pages including a main area and a spare area, and the storage controller may be configured to store the part of the scrambled data in the main area and store the part of the hash value in the spare area.

In some example embodiments, the storage controller may be configured to read the plurality of pieces of the encoded data from the plurality of nonvolatile memories, decode the plurality of pieces of the encoded data into the scrambled data and the hash value, and generate descrambled data by descrambling the decoded scrambled data and the decoded hash value.

In some example embodiments, the storage controller may be configured to read the plurality of pieces of the encoded data from the plurality of nonvolatile memories, decode the plurality of pieces of the encoded data into the scrambled data and the hash value, generate an encryption key by encrypting the decoded hash value with a private key of a server including the storage device, and transmit the decoded scrambled data and the encryption key to an external client.

In some example embodiments, the memory may include a plurality of nonvolatile memories, and the storage controller may be configured to encode the scrambled data into a plurality of pieces of encoded data, and distribute and stores the plurality of pieces of encoded data and the hash value in the plurality of nonvolatile memories.

In some example embodiments, the storage controller may be configured to read a plurality of encoded data and a hash value from a plurality of nonvolatile memory, decode a plurality of pieces of encoded data into scrambled data, and decode the decoded scrambled data and a plurality of hash values read from the plurality of nonvolatile memories, and generate descrambled data by descrambling the value.

In some example embodiments, the memory may include a secure area, and the storage controller may be configured to store the hash value in the secure area.

In some example embodiments, the storage controller may be configured to generate descrambled data by descrambling the scrambled data and the hash value, and determine whether the descrambled data are falsified.

In some example embodiments, the storage controller may be configured to receive input data and a public key of a client from an external client, generate a hash value using the output value of a random number generator, encrypt the hash value with the public key of the client to generate an encryption key, and store the scrambled data and encryption key in association with each other in the memory.

In some example embodiments, the storage controller may be configured to generate a hash value using the output value of a random number generator, encrypt the output value of the random number generator with the private key of the server including the storage device to generate an encryption key, and store scrambled data and encryption key in association with each other in the memory.

In some example embodiments, the storage controller may be configured to receive the input data, the first encryption key, and the public key of the client from the external client, and generate a hash value by using the decrypted value of the encryption key as the public key of the client.

According to some aspects of the inventive concepts, there is provided a data processing method according to some example embodiments includes receiving input data; generating a hash value; generating scrambled data by scrambling the input data with the hash value; and storing the scrambled data with the hash value in association with each other in a memory.

In some example embodiments, the data processing method may further include reading the scrambled data and the hash value from the memory; generating descrambled data by descrambling the scrambled data read from the memory and the hash value read from memory; and determining whether the descrambled data has been falsified.

According to some aspects of the inventive concepts, there is provided a storage system according to some example embodiments includes at least one client, and a server that may be configured to receive contents data from a first client among at least one client, generate a hash value, generate scrambled data by scrambling the contents data with the hash value, and store an encrypted key encrypted from the hash value and the scrambled data in association with each other in a memory.

In some example embodiments, the server may further be configured to receive a public key of the first client from the first client, generate an encryption key by encrypting the hash value as the public key of the first client, and transmit the scrambled data and encryption key read from the memory to the first client.

In some example embodiments, the server may be configured to generate an encryption key by encrypting the hash value as a private key of the server, and may transmit the scrambled data read from memory, the encryption key, and the server's private key to the first client.

### BRIEF DESCRIPTION OF THE DRAWINGS

FIG. 1 is a block diagram of a storage system according to some example embodiments.

FIG. 2 is a block diagram of the storage device according to some example embodiments.

FIG. 3 and FIG. 4 are flowcharts of an operation method of the storage according to some example embodiments.

FIG. 5 is a block diagram of a protect module of the storage device according to some example embodiments.

FIG. 6 exemplarily illustrates data scrambling of the storage device according to some example embodiments.

FIG. 7 is a block diagram of a nonvolatile memory of the storage device according to some example embodiments.

FIG. 8 and FIG. 9 are diagrams for description of data descrambling of the storage device according to some example embodiments.

FIG. 10 is a block diagram of a protect module of a storage device according to some example embodiments.

FIG. 11 is a block diagram of a nonvolatile memory of a storage device according to some example embodiments.

FIG. 12 is a block diagram of a protect module of a storage device according to some example embodiments.

FIG. 13 is a block diagram of a nonvolatile memory of a storage device according to some example embodiments.

FIG. 14 is a block diagram of a protect module of a server according to some example embodiments.

FIG. 15 is a protect module of a client according to some example embodiments.

FIG. 16 is a block diagram of a protect module of a server according to some example embodiments.

FIG. 17 is a block diagram of a protect module of a client according to some example embodiments.

FIG. 18 is a block diagram of a protect module of a server according to some example embodiments.

FIG. 19 is a block diagram of an example of application of the storage device according to some example embodiments to a solid-state drive (SSD).

### DETAILED DESCRIPTION

In the following detailed description, only certain example embodiments of the present inventions have been shown and described, simply by way of illustration. As those skilled in the art would realize, the described embodiments may be modified in various different ways, all without departing from the spirit or scope of the present inventions.

Accordingly, the drawings and description are to be regarded as illustrative in nature and not restrictive. Like reference numerals designate like elements throughout the specification. In the flowchart described with reference to the drawing, the order of operations may be changed, several operations may be merged, some operations may be divided, and specific operations may not be performed.

In addition, expressions written in the singular may be construed as singular or plural unless explicit expressions such as “one” or “single” are used. Terms including ordinal numbers such as first, second, and the like may be used to describe various configurations elements, but constituent elements are not limited by these terms. These terms may be used for the purpose of distinguishing one constituent element from other constituent elements.

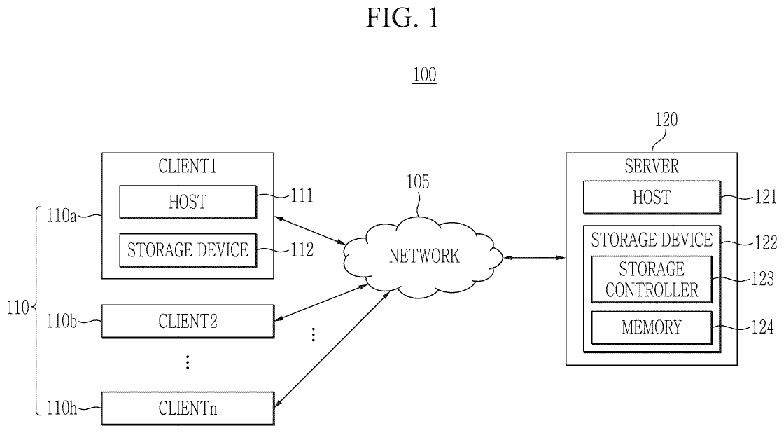

FIG. 1 is a block diagram of a storage system according to some example embodiments.

Referring to FIG. 1, a storage system 100 may include at least one of clients 110a to 110h (client 110a, 110b, . . . 110h, etc.) and a server 120. At least one of the clients 110a to 110h and the server 120 may be connected to each other through a network fabric 105. The client 110 may request or transmit data to the server 120, and the server 120 may also request or transmit data to the client 110.

At least one client (e.g., 110a) may include a host 111 and a storage device 112. The host 111 may control the storage device 112.

In some example embodiments, the client 110 may transmit contents data to the server 120 through the network fabric 105. The client 110 may create or edit content such as still images, video images, and audio content. In some example embodiments, the client 110 may transmit the contents data stored in the storage device 112 to the server 120.

In some example embodiments, the client 110 may receive the contents data from the server 120. In some example embodiments, the client 110 may descramble the received contents data using a private key or a public key of the client 110a. The client 110 may use the private key of the client 110a or the public key of the server 120 to decrypt a hash value from an encryption key received from the server 120. The client 110 may use the decrypted hash value to descramble the contents data.

In some example embodiments, the client 110 may generate an encryption key by encrypting an output value of a random number generator with the private key of the client 110. The client 110 may generate an encryption key and transmit the generated encryption key to the server 120 together with the contents data. In addition, the client 110 may receive the public key of the server 120, the encryption key, and the contents data from the server 120, decrypt the received encryption key with the public key of the server 120, and decode the contents data by using the decrypted value.

The server 120 may include a host 121 and a storage device 122. The host 121 may control the storage device 122.

The host 121 may communicate with the client 110 through the network fabric 105. The host 121 may transmit the data transmitted from the client 110 to the storage device 122. The host 121 may transmit the data of the storage device 122 to the client 110.

The host 121 may determine whether data stored in the storage device 122 has been falsified. In some example embodiments, the host 121 may determine whether the contents data stored in the storage device 122 is falsified. For example, the host 121 may determine whether the stored contents data are falsified by using random noise detection, edge detection, and data difference calculation between frames of the contents data.

The operation of the host 121 described above may also be performed by a storage controller 123.

The host 121 may communicate with the storage device 122 through various interfaces. As an example, the host 121 may communicated with the storage device 122 through various interfaces such as a USB (Universal Serial Bus), MMC (MultiMediaCard), PCI-E (PCIExpress), ATA (AT Attachment), SATA (Serial AT Attachment), PATA (Parallel AT Attachment), SCSI (Small Computer System Interface), SAS (Serial Attached SCSI), ESDI (Enhanced Small Disk Interface), IDE (Integrated Drive Electronics), NVMe (Non-Volatile Memory Express), and the like.

The storage device 122 may include a storage controller 123 and a memory 124.

In some example embodiments, the storage controller 123 may receive the contents data transmitted to the server 120 by the client 110. In some example embodiments, the storage controller 123 may scramble the received contents data. The storage controller 123 may generate a hash value from a part of the received contents data and scramble the contents data using the hash value. The storage controller 123 may generate a hash value from an output value of a random number generator and scramble the contents data using the hash value.

In some example embodiments, the storage controller 123 may receive the public key of the client 110, encryption key, and contents data. The storage controller 123 may decrypt the encryption key as the public key of the client 110 and generate a hash value using the decrypted value. The storage controller 123 may use the hash value to scramble the contents data.

In some example embodiments, the storage controller 123 may store the scrambled contents data in the memory 124. In some example embodiments, the storage controller 123 may encode the scrambled contents data together with a hash value and store the encoded data in the memory 124. In some example embodiments, the storage controller 123 may store the scrambled contents data and the hash value in separate regions within the memory 124, respectively. In this case, the storage controller 123 may encode only the scrambled contents data and store it in the memory 124.

In some example embodiments, the storage controller 123 may decode data stored in the memory 124. In some example embodiments, the storage controller 123 may extract a hash value by decoding the contents data stored in the memory 124, and descramble the extracted hash value and contents data. In some example embodiments, the storage controller 123 may descramble the contents data stored in the memory 124 by using a hash value stored in a predetermined region of the memory 124.

In some example embodiments, the storage controller 123 may determine whether the contents data stored in the memory 124 is falsified. For example, the storage controller 123 may determine whether the stored contents data are falsified using random noise detection, edge detection, and data difference calculation between frames of the decoded contents data.

In some example embodiments, the storage controller 123 may transmit the contents data stored in the memory 124 to the client 110. In some example embodiments, the storage controller 123 may transmit the contents data stored in the memory 124 and the encryption key to the client 110. For example, the storage controller 123 may generate an encryption key by encrypting an output value of a random number generator using the private key of the storage controller 123 or the public key of the client 110. In some example embodiments, the storage controller 123 may extract a hash value from the contents data of the client 110 stored in the memory 124, encrypt the hash value with the private key of the storage controller 123 to generate an encryption key, and transmit the contents data and the encryption key to the client 110.

The operation of the storage controller 123 described above may also be performed by the host 121.

The storage device 122 may include storage media for storing data according to a request from the host 121. For example, the storage device 122 may include at least one solid state drive (SSD). When the storage device 122 includes an SSD, the memory 124 may include a plurality of flash memory chips (e.g., NAND memory chips) for nonvolatile storage of data. Meanwhile, the memory 124 may correspond to one flash memory device, or the memory 124 may include a memory card including at least one flash memory chip.

When the storage device 122 includes a flash memory, the flash memory may include a 2D NAND memory array and/or a 3D (or vertical) NAND (VNAND) memory array. A 3D memory array is a circuit related to the operation of arrays of memory cells having an active region disposed on a silicon substrate, or memory cells formed on or within a substrate, and is formed monolithically in at least one physical level of the circuit. The term “monolithic” means that layers of each level constituting the array are stacked directly on top of the layers of each lower level in the array. The 3D memory array includes vertical NAND strings disposed in a vertical direction such that at least one memory cell is positioned on top of another memory cell. At least one memory cell may include a charge trap layer.

In some example embodiments, the storage device 122 may include other various types of memories. For example, the storage device 122 may contain nonvolatile memory, various types of memories such as a magnetic RAM (MRAM), a spin-transfer torque MRAM (MRAM), a conductive bridging RAM (CBRAM), a ferroelectric RAM (FeRAM), a phase RAM (PRAM), a resistive RAM, a nanotube RAM, a polymer RAM (PoRAM), a nano-floating gate memory (NFGM), a holographic memory, a molecular electronics memory, an insulator resistance change memory, and/or the like are applicable.

The memory 124 may be an embedded multi-media card (eMMC) or an embedded universal flash storage (UFS) memory device. For example, the memory 124 may be an external memory detachable from the storage device 122. Specifically, the memory 124 may be a UFS memory card, a compact flash, a secure digital (SD), a micro-secure digital (Micro SD), a mini-SD, an extreme digital (xD), or a memory stick, but is not limited thereto.

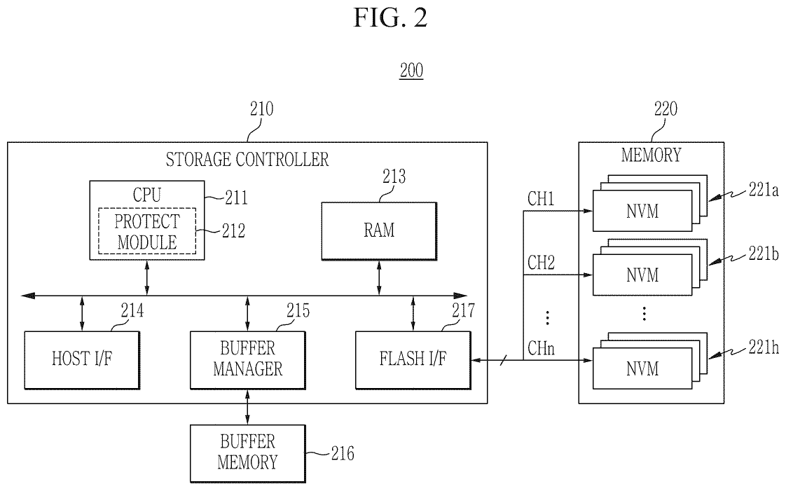

FIG. 2 is a block diagram of the storage device according to some example embodiments.

Referring to FIG. 2, the storage device 200 may include the storage controller 210 and a nonvolatile memory device 220.

The storage controller 210 may access the nonvolatile memory device 220 and a buffer memory 216. The storage controller 210 may perform write, read, and erase operations according to a request from an external host device. The storage controller 210 may write write-requested data to the nonvolatile memory device 220 and read and output the read-requested data from the nonvolatile memory device 220.

The storage controller 210 may manage the nonvolatile memory device 220 using the buffer memory 216. For example, the storage controller 210 may temporarily store data to be written to the nonvolatile memory device 220 or data read from the nonvolatile memory device 220 in the buffer memory 216.

The storage controller 210 may include a CPU 211, a random access memory (hereinafter, RAM) 213, a host interface 214, a buffer manager 215, and a flash interface 217.

The CPU 211 may control the entire operation of the storage controller 210, and may perform a logical operation. The CPU 211 may communicate with the host 121 (in FIG. 1) through the host interface 214, communicate with the nonvolatile memory device 220 through the flash interface 217, and communicate with the buffer memory 216 through the buffer manager 215. The CPU 211 can control the nonvolatile memory device 220 by using the RAM 213 as an operating memory, cache memory, or buffer memory.

The CPU 211 may include a protect module 212. The protect module 212 may perform operations such as encoding/decoding and scrambling/disk-rambling of contents data, and generation of an encryption key and decryption of an encryption key.

The RAM 213 may be used as the operating memory, the cache memory, or the buffer memory of the CPU 211. The RAM 213 may store codes and instructions executed by the CPU 211. The RAM 213 may store data processed by the CPU 211. The RAM 213 may be implemented as a static RAM (SRAM), as an example. Particularly, a read level control module (RL control module) may be stored in the RAM 213. In addition, the RAM 213 may store a flash translation layer (FTL) or various memory management modules. The flash translation layer may perform functions such as address mapping, garbage collection, and wear leveling for interfacing between the nonvolatile memory device 220 and the host 121 (in FIG. 1).

The host interface 214 may communicate with an external host device under the control of the CPU 211. The host interface 214 may be configured to communicate using at least one of various communication methods such as a universal serial bus (USB), a serial AT attachment (SATA), a serial attached SCSI (SAS), a high speed interchip (HSIC), a small computer system interface (SCSI), a peripheral component interconnection (PCI), a PCI express (PCIe), a nonvolatile memory express (NVMe), a universal flash storage (UFS), a secure digital (SD), a multimedia card (MMC), an embedded MMC (eMMC), a dual in-line memory module (DIMM), a registered DIMM (RDIMM), a load reduced DIMM (LRDIMM), and the like.

The buffer manager 215 may control the buffer memory 216 according to the control of the CPU 211. The buffer manager 215 may control the buffer memory 216 to temporarily store the data exchanged between the nonvolatile memory device 220 and the host (121 in FIG. 1).

The flash interface 217 may communicate with the nonvolatile memory device 220 according to the control of the CPU 211. The flash interface 217 may communicate with the nonvolatile memory device 220 through a plurality of channels CH1 to CHn. Specifically, the flash interface 217 may transmit/receive commands, addresses, and data to/from the nonvolatile memory device 220 through a plurality of channels CH1 to CHn.

The nonvolatile memory device 220 may perform a write operation, a read operation, and an erase operation according to the control of the storage controller 210. The nonvolatile memory device 220 may receive a write command, an address, and data from the storage controller 210, and write data to a storage space identified by the address. The nonvolatile memory device 220 may receive a read command and an address from the storage controller 210, read data from a storage space identified by the address, and output the read data to the storage controller 210. The nonvolatile memory device 220 may receive an erase command and an address from the storage controller 210 and erase data in the storage space identified by the address.

The nonvolatile memory device 220 may include a plurality of memories 221a to 221h. For example, each of the nonvolatile memories 221a to 221h may be a NAND (Not AND) flash memory. Each of the nonvolatile memories 221a to 221h may include a plurality of memory blocks. Each of a plurality of memory blocks may include a plurality of memory cells. A plurality of memory cells may form a storage space of the nonvolatile memory device 220. A plurality of memory cells may be divided into a main area for storing main data and a spare area for storing additional data such as a parity bit. In some example embodiments, one page containing a plurality of memory cells that are programmed simultaneously may be divided into a main area and a spare area. Each of the plurality of memory blocks may further include a selection transistor that supports individually selecting a plurality of memory cells.

The nonvolatile memory device 220 may include a flash memory, a phase-change random access memory (PRAM), a ferroelectric random access memory (FeRAM), a magnetic random access memory (MRAM), a resistive random access memory (RRAM), and the like. The nonvolatile memory device 220 may be configured in the form of, for example, a solid state drive (SSD), a memory card, or an embedded memory card, but it will be understood that the present invention is not limited thereto.

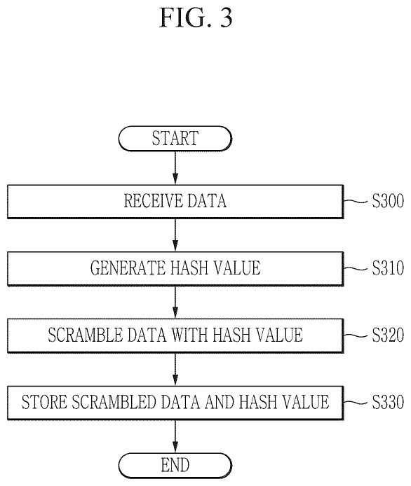

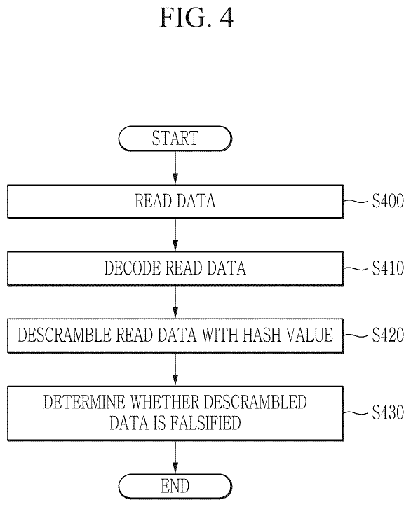

Hereinafter, referring to FIG. 3 and FIG. 4, an operation method of the storage device will be described.

FIG. 3 and FIG. 4 are flowcharts of an operation method of the storage according to some example embodiments.

Referring to FIG. 2 and FIG. 3, the storage controller 210 receives data from the host (S300). The storage controller 210 may receive contents data from the host through the host interface 214. In some example embodiments, the storage controller 210 may receive an encryption key for generating a hash value for encoding contents data from the host. The storage controller 210 may receive a public key of a client for decrypting the encryption key from the host.

The storage controller 210 generates a hash value (S310). In some example embodiments, the CPU 211 (or, for example, protect module 212 which may be included in the CPU 211) may generate a hash value from a part of the received contents data. In some example embodiments, the CPU 211 (or, for example, protect module 212 which may be included in the CPU 211) may generate a hash value from the output value of the random number generator. In some example embodiments, the CPU 211 (or, for example, protect module 212 which may be included in the CPU 211) may receive an encryption key from the host, decrypt the encryption key using the host's public key, and generate a hash value using the decrypted value. The CPU 211 or, for example, the protect module 212 which may be included in the CPU 211 may generate a hash value using a hash algorithm such as SHA256, SHA512, or CRC.

The storage controller 210 scrambles data with the hash value (S320). In some example embodiments, the CPU 211 (or, for example, protect module 212 which may be included in the CPU 211) may scramble the contents data using the hash value. For example, the CPU 211 or, for example, the protect module 212 which may be included in the CPU 211 may perform scrambling by performing an XOR operation on the hash value and the contents data.

The storage controller 210 stores the scrambled data and hash value (S330). The CPU 211 or, for example, the protect module 212 which may be included in the CPU 211 may encode the scrambled contents data into at least one piece of encoding data. In some example embodiments, the CPU 211 (or, for example, protect module 212 which may be included in the CPU 211) may encode the scrambled contents data together with a hash value. In some example embodiments, the CPU 211 (or, for example, protect module 212 which may be included in the CPU 211) may encode only the scrambled contents data.

The CPU 211 (or, for example, the protect module 212 which may be included in the CPU 211) may store the encoded data in the nonvolatile memory device 220. The CPU 211 (or, for example, the protect module 212 which may be included in the CPU 211) may store encoded data in the nonvolatile memory device 220 through the flash interface 217. In some example embodiments, the CPU 211 (or, for example, the protect module 212 which may be included in the CPU 211) may store at least one piece of encoded data in a corresponding memory among a plurality of memories 221a to 221h. For example, the CPU 211 (or, for example, the protect module 212 which may be included in the CPU 211) may encode the scrambled contents data into i pieces (i is a positive number) of encoded data, and distribute them to i memories among the plurality of memories 221a to 221h, respectively.

In some example embodiments, each piece of the encoding data may include a part of the scrambled contents data and a part of the hash value. The CPU 211 (or, for example, the protect module 212 which may be included in the CPU 211) may store a part of the scrambled contents data by associating it with a part of the hash value. In some example embodiments, the CPU 211 (or, for example, the protect module 212 which may be included in the CPU 211) may store a part of the scrambled contents data and a part of the hash value in a related region of a corresponding memory among memories 221a to 221h. For example, the CPU 211 (or, for example, the protect module 212 which may be included in the CPU 211) stores a part of the scrambled contents data in a main region of a selected page in a corresponding memory among the plurality of memories 221a to 221h, and stores a part of the hash value in a spare region of the selected page. In some example embodiments, each of the encoded data may include a corresponding j bit value (j is a positive number) among hash values. For example, when the hash value is formed of 512 bits and i is an integer exceeding 512, each of the i pieces of encoded data may include at least one corresponding bit value among 512 bits of the hash value. When the hash value is formed of 512 bits and i is an integer exceeding 512, at least two pieces of the encoded data among the i pieces of encoded data may include the same bit value among 512 bits of the hash value.

In some example embodiments, each piece of the encoding data may include only a portion of the scrambled contents data. The CPU 211 (or, for example, the protect module 212 which may be included in the CPU 211) may store the encoded data in a corresponding memory among the plurality of memories 221a to 221h, and store the hash value in a secure region of the nonvolatile memory device 220.

Referring to FIG. 2 and FIG. 4, the storage controller 210 reads data from the nonvolatile memory device 220 (S400). The storage controller 210 may read the encoded data stored in the nonvolatile memory device 220 through the flash interface 217.

In some example embodiments, the storage controller 210 may read the hash value together from the secure region of the nonvolatile memory device 220. In some example embodiments, the storage controller 210 may read an encryption key from the secure region of the nonvolatile memory device 220. The storage controller 210 may decrypt the encryption key as the client's public key, and generate a hash value using the decrypted value.

The CPU 211 (or, for example, the protect module 212 which may be included in the CPU 211) decodes the encoded data (S410). The CPU 211 (or, for example, the protect module 212 which may be included in the CPU 211) may generate scrambled data by decoding the encoded data. In some example embodiments, the CPU 211 (or, for example, the protect module 212 which may be included in the CPU 211) may decode the encoded data to extract the hash value.

The CPU 211 (or, for example, the protect module 212 which may be included in the CPU 211) performs descrambling of the scrambled data using a hash value (S420). For example, the CPU 211 (or, for example, the protect module 212 which may be included in the CPU 211) may perform descrambling by performing an XOR operation on the hash value and the scrambled data.

The CPU 211 (or, for example, the protect module 212 which may be included in the CPU 211) determines whether the descrambling data are falsified (S430). The CPU 211 (or, for example, the protect module 212 which may be included in the CPU 211) may determine whether the stored contents data are falsified using random noise detection, edge detection, and data difference calculation between frames of the decoded contents data.

Since the storage device 200 according to some example embodiments scrambles the hash value and data and stores it, when the stored data and/or the stored hash value is falsified, it is possible to determine whether the falsified data are falsified using the descrambled data.

Since the storage device 200 according to some example embodiments stores the hash value in the spare region or the secure region, falsification (which may be, for example, malicious or deceptive) of the hash value can be prevented or reduced.

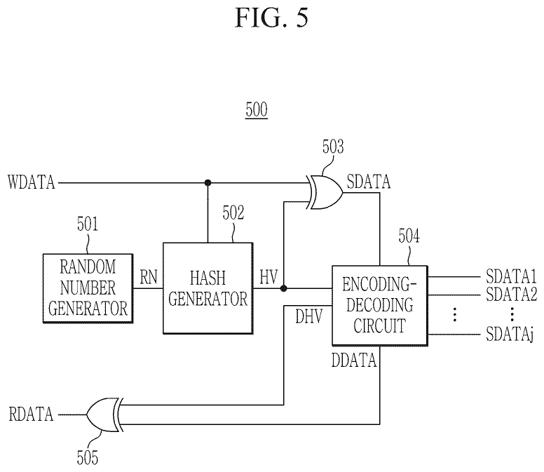

Next, referring to FIG. 5, a protect module according to some example embodiments will be described.

FIG. 5 is a block diagram of a protect module of the storage device according to some example embodiments.

Referring to FIG. 5, a protect module 500 may include a random number generator 501, a hash generator 502, exclusive OR (XOR) gates 503 and 505, and an encoding-decoding circuit 504.

The random number generator 501 may generate a random number (RN). The random number generator 501 may be implemented as a hardware random number generator (HRNG) or a pseudo random number generator (PRNG).

The hash generator 502 may output a hash value HV using a hash algorithm. The hash algorithm of the hash generator 502 is a function that converts an input value having an arbitrary length into an output value of a fixed length. In this case, the output value is called a hash value HV. In some example embodiments, the hash generator 502 may generate a hash value HV using a random number RN. In some example embodiments, the hash generator 502 may generate a hash value HV using input data WDATA.

In some example embodiments, the hash generator 502 may generate a plurality of hash values HV. For example, the hash generator 502 may output a second hash value by applying the hash algorithm to a first hash value generated by applying a hash algorithm to a random number RN. Similarly, the hash generator 502 may generate a third hash value by re-applying the hash algorithm to the second hash value.

The XOR gate 503 may generate scrambled data SDATA using the input data WDATA and a hash value HV. To generate the scrambled data SDATA, the XOR gate 503 may perform an exclusive OR operation on the input data WDATA and the hash value HV. When there are a plurality of hash values HV, the XOR gate 503 may perform an exclusive OR operation on the input data WDATA and the plurality of hash values HV.

One of input terminals of the XOR gate 503 may be connected to a receiving terminal of the input data WDATA. The rest of the input terminals of the XOR gate 503 may be connected to output terminals of the hash generator 502.

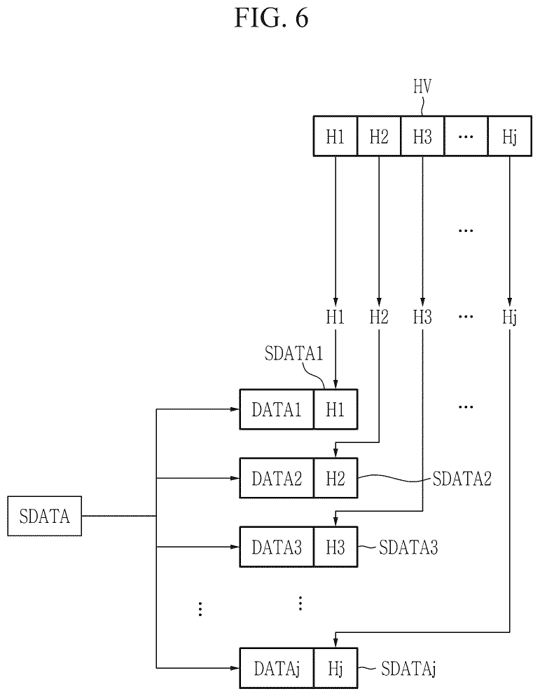

The encoding-decoding circuit 504 may encode the scrambled data SDATA and the hash value HV into a plurality of pieces of encoding data SDATA1 to SDATAj. The encoding-decoding circuit 504 may generate a plurality of pieces of encoding data SDATA1 to SDATAj such that a bit value of the hash value HV is distributed to the plurality of pieces of the encoding data SDATA1 to SDATAj. Therefore, since each of the plurality of pieces of the encoding data SDATA1 to SDATAj may include at least one bit value corresponding to the hash value, after a plurality of pieces of the encoding data SDATA1 to SDATAj are decoded, the hash value HA distributed to the plurality of pieces of the encoding data SDATA1 to SDATAj may be restored. A method for encoding the scrambled data SDATA and the hash value HV into the plurality of pieces of the encoding data SDATA1 to SDATAj will be described with reference to FIG. 6.

FIG. 6 exemplarily illustrates data scrambling of the storage device according to some example embodiments.

Referring to FIG. 6, the encoding-decoding circuit 504 may divide the scrambled data SDATA into a plurality of pieces of data DATA1 to DATAj. The encoding-decoding circuit 504 may divide the hash value HV into a plurality of bit values H1 to Hj. The encoding-decoding circuit 504 may encode a plurality of pieces of data DATA1 to DATAj and a plurality of bit values H1 to Hj into a plurality of pieces of encoding data SDATA1 to SDATAj. Each of the plurality of pieces of encoding data SDATA1 to SDATAj may include at least one corresponding bit value of the plurality of pieces of data DATA1 to DATAj and at least one corresponding bit value of the plurality of bit values H1 to Hj.

Each of the plurality of pieces of data DATA1 to DATAj is stored in a main area, and each of a plurality of bit values H1 to Hj is stored in a spare area associated with the main area in which corresponding data of the plurality of pieces of data DATA1 to DATAj is stored. For example, data DATA1 may be stored in the main area of the selected page, and the bit value H1 may be stored in the selected page.

Here, the number of bits of each of the plurality of bit values H1 to Hj may be at least one bit. The number of bits of the plurality of bit values H1 to Hj may be determined by the number of bits of the hash value HV and the plurality of pieces of data DATA1 to DATAj. For example, when the hash value HV is 512 bits and the scrambled data SDATA are divided into 256 pieces of data, each of the plurality of bit values H1 to Hj may be 2 bits. When the hash value HV is 512 bits and the scrambled data SDATA are divided into 512 pieces of data, each of the plurality of bit values H1 to Hj may be 1 bit. When the hash value HV is 512 bits and the scrambled data SDATA are divided into 1024 pieces of data, each of the plurality of bit values H1 to Hj may be 1 bit. In this case, at least two pieces of data from which the scrambled data SDATA are divided may have the same one bit value among the plurality of bit values H1 to Hj.

Although it has been described above that the scrambled data SDATA and one hash value HV are encoded, the encoding-decoding circuit 504 may encode the scrambled data SDATA and the plurality of hash values. In this case, each of the plurality of pieces of encoding data SDATA1 to SDATAj may include at least one bit value of at least one hash value among the plurality of hash values.

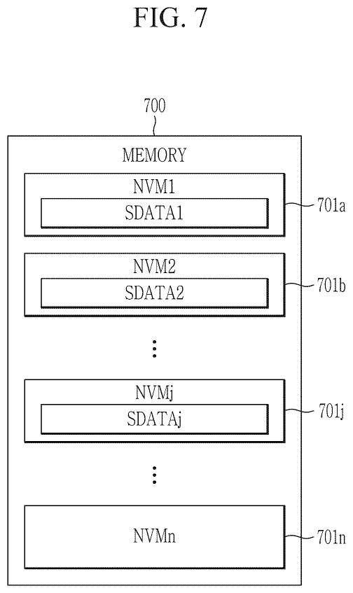

Referring back to FIG. 5, the encoding-decoding circuit 504 may output a plurality of pieces of encoding data SDATA1 to SDATAj to the flash interface. Each of the plurality of pieces of encoding data SDATA1 to SDATAj may be stored in a corresponding memory among a plurality of memories. Referring to FIG. 7, the plurality of pieces of encoding data SDATA1 to SDATAj stored in the memory will be described.

FIG. 7 is a block diagram of a nonvolatile memory of the storage device according to some example embodiments.

Referring to FIG. 7, a nonvolatile memory device 700 may include a plurality of memories NVM1 to NVMn 701a to 701n. The flash interface may distribute and store the plurality of pieces of encoding data SDATA1 to SDATAj in the plurality of memories 701a to 701n. For example, each of the plurality of memories 701a to 701n may store a corresponding one of the plurality of pieces of encoding data SDATA1 to SDATAj. In the storage device according to some example embodiments, since the plurality of pieces of encoding data SDATA1 to SDATAj are stored in different memories NVM1 to NVMj, it is possible to reduce the risk that the entire original data are modified.

Referring back to FIG. 5, the encoding-decoding circuit 504 may decode the plurality of pieces of encoding data SDATA1 to SDATAj to generate decoded data DDATA and a decoded hash value DHV.

The XOR gate 505 may generate descrambled data RDATA by using the decoded data DDATA and the decoded hash value DHV. In order to generate descrambled data RDATA, the XOR gate 505 may perform an exclusive OR operation of decoded data DDATA and decoded hash value DHV.

When a plurality of hash values HV are used to generate the scrambled data SDATA, like the generating the plurality of hash values HV, the hash generator 502 may generate a plurality of decoded hash values by applying a hash algorithm to the decoded hash value DHV. Then, the XOR gate 505 may perform an exclusive OR operation on the decoded data DDATA and the plurality of decoded hash values DHV.

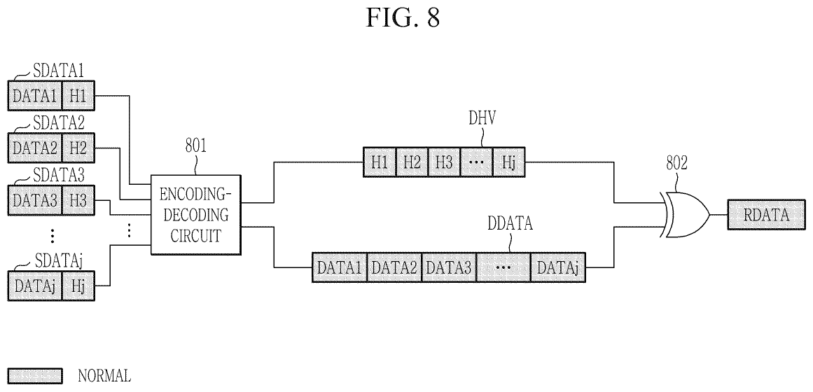

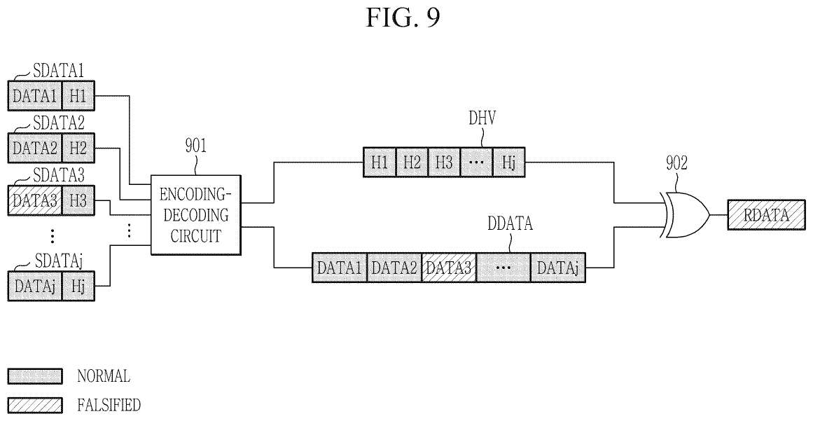

One of input terminals of the XOR gate 505 may receive decoded data DDATA from the encoding-decoding circuit 504. The rest of the input terminals of the XOR gate 503 may be connected to output terminals of the encoding-decoding circuit 504 and/or the hash generator 502 to receive the decoded hash value DHV. Related to this, referring to FIG. 8 and FIG. 9, a method for generating the descrambled data RDATA will be described.

FIG. 8 and FIG. 9 are diagrams for description of data descrambling of the storage device according to some example embodiments.

Referring to FIG. 8, an encoding-decoding circuit 801 may decode a plurality of pieces of encoding data SDATA1 to SDATAj read from a plurality of memories into a decoded hash value DHV and decoded data DDATA.

The XOR gate 802 may generate descrambled data RDATA by performing an exclusive OR operation on the decoded hash value DHV and the decoded data DDATA.

Whether the descrambled data RDATA are falsified may be determined by the CPU 211 (of FIG. 2, or, for example, the protect module 212 which may be included in the CPU 211 of FIG. 2) using random noise detection, edge detection, and data difference calculation between frames. When a plurality of pieces of encoding data SDATA1 to SDATAj are all normal (for example, free from detected errors, not falsified), the descrambled data RDATA generated therefrom may be determined to be normal.

Referring to FIG. 9, an encoding-decoding circuit 901 may decode a plurality of pieces of encoding data SDATA1 to SDATAj read from a plurality of memories into a decoded hash value DHV and decoded data DDATA.

The XOR gate 902 may generate descrambled data RDATA by performing an exclusive OR operation on the decoded hash value DHV and the decoded data DDATA.

Whether the descrambled data RDATA are falsified may be determined by the CPU 211 (of FIG. 2, or, for example, the protect module 212 which may be included in the CPU 211 of FIG. 2) using random noise detection, edge detection, and data difference calculation between frames. When data DATA3 of the encoding data SDATA3 among the plurality of pieces of encoding data SDATA1 to SDATAj is falsified, the descrambled data RDATA generated therefrom may have random noise by descrambling. When the descrambled data RDATA are image data, edge detection in one frame image may be abnormal, or a difference in RGB data values between consecutive frame images may be abnormal.

Since the hash value DHV and the decoded data DDATA are descrambled to generate descrambled data RDATA, when some of the plurality of pieces of encoding data SDATA1 to SDATAj are falsified (which may be done, for example, maliciously or deceptively), the falsified data affects the entire descrambled data RDATA. Therefore, the storage device according to some example embodiments can be possible to determine whether data are falsified. For example, according to example embodiments, it may be easy to determine whether data is falsified.

In addition, since each of the plurality of bit values H1 to Hj of the hash value HV is distributed and stored in the spare area, it cannot be arbitrarily changed by a user, and when some values of the plurality of bit values H1 to Hj are falsified (which may be done, for example, maliciously or deceptively), the falsified value may affect the entire descrambled data RDATA. Therefore, the storage device according to some example embodiments can determine whether data are modified.

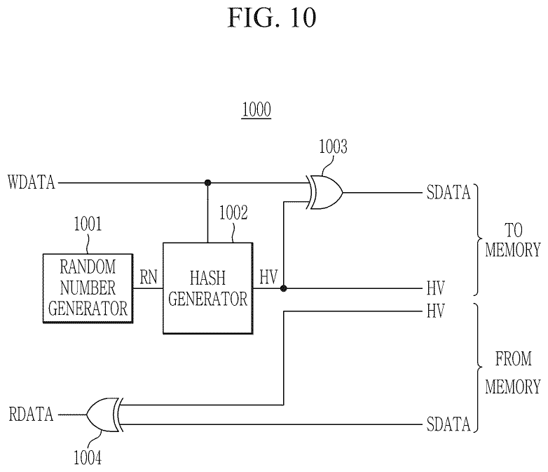

FIG. 10 is a block diagram of a protect module of a storage device according to some example embodiments.

Referring to FIG. 10, a protect module 1000 may include a random number generator 1001, a hash generator 1002, and XOR gates 1003 and 1004. Descriptions of the same or similar operations to the random number generator 501, the hash generator 502, and the XOR gate 503 and 505 of FIG. 5 will be omitted.

The hash generator 1002 may output a hash value HV using a hash algorithm. The hash generator 1002 may output the hash value HV to the flash interface such that the hash value HV can be stored in a memory. The hash value HV may be stored in memory through the flash interface.

The XOR gate 1003 may generate scrambled data SDATA using input data WDATA and the hash value HV. XOR gate 1003 may output scrambled data SDATA to the flash interface to store the scrambled data SDATA in the memory. The scrambled data SDATA may be stored in the memory through the flash interface.

The scrambled data SDATA may be stored in one corresponding memory among a plurality of memories. The hash value HV may be stored in a secure area of the corresponding one of the plurality of memories.

The XOR gate 1004 may generate descrambled data RDATA by using the scrambled data SDATA and hash value HV read from the memory.

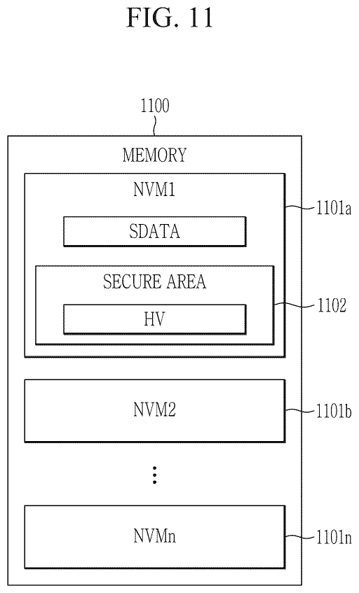

Referring to FIG. 11, the scrambled data SDATA and the hash value HV stored in the memory will be described.

FIG. 11 is a block diagram of a nonvolatile memory of a storage device according to some example embodiments.

Referring to FIG. 11, a nonvolatile memory device 1100 may include a plurality of memories NVM1 to NVMn 1101a to 1101n.

In some example embodiments, a flash interface may store scrambled data SDATA and a hash value HV in one memory 1101a among a plurality of memories 1101a to 1101n. The flash interface may store the hash value HV in a secure area 1102 of the memory 1101a.

In some example embodiments, the flash interface may store the scrambled data SDATA in one memory 1101a of a plurality of memories 1101a to 1101n, and the hash value HV in a secure area of any one of the plurality of memories 1101a to 1101n that is different from the memory 1101a in which the scrambled data SDATA are stored among other memories 1101b to 1101n.

The hash value HV stored in the secure area 1102 of the memory 1101a may be maintained in a secure state. As such, the storage device 1100 supporting the self-encryption function may be referred to as a self-encrypting device or self-encrypting drive (SED).

In some example embodiments, the secure area 1102 may include a reserved area and/or an over provisioning area. The over provisioning area is a region used to maintain and manage storage devices. Examples of maintenance and management include trim, garbage collection, and replacement of bad blocks.

In the storage device according to some example embodiments, since the hash value HV is stored in the secure area 1102, even if the scrambled data SDATA are falsified, it can be determined that the falsified scrambled data SDATA are descrambled with the hash value HV.

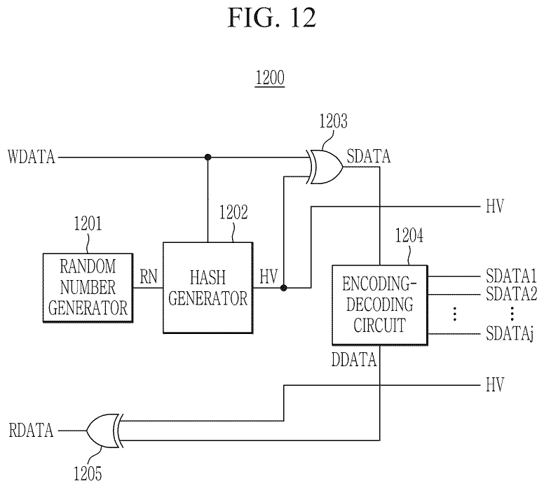

FIG. 12 is a block diagram of a protect module of a storage device according to some example embodiments.

Referring to FIG. 12, a protect module 1200 may include a random number generator 1201, a hash generator 1202, XOR gates 1203 and 1205, and an encoding-decoding circuit 1204. Descriptions of the same or similar operations to the random number generator 501, the hash generator 502, the XOR gates 503 and 505, and the encoding-decoding circuit 504 of FIG. 5 will be omitted.

The hash generator 1202 may output a hash value HV using a hash algorithm. The hash generator 1202 may output the hash value HV to a flash interface such that the hash value HV may be stored in a memory. The hash value HV may be stored in the memory through the flash interface.

The XOR gate 1203 may generate scrambled data SDATA using input data WDATA and a hash value HV.

The encoding-decoding circuit 1204 may encode the scrambled data SDATA into a plurality of pieces of encoding data SDATA1 to SDATAj. The encoding-decoding circuit 1204 may output a plurality of pieces of encoding data SDATA1 to SDATAj to the flash interface. Each of the plurality of pieces of encoding data SDATA1 to SDATAj may be stored in a corresponding memory among a plurality of memories.

The encoding-decoding circuit 1204 may decode a plurality of pieces of encoding data SDATA1 to SDATAj read from the memory to generate decoded data DDATA.

The XOR gate 1205 may generate descrambled data RDATA using the decoded data DDATA and the hash value HV read from the memory. To generate the descrambled data RDATA, the XOR gate 1205 may perform an exclusive OR operation on the decoded data DDATA and the hash value HV.

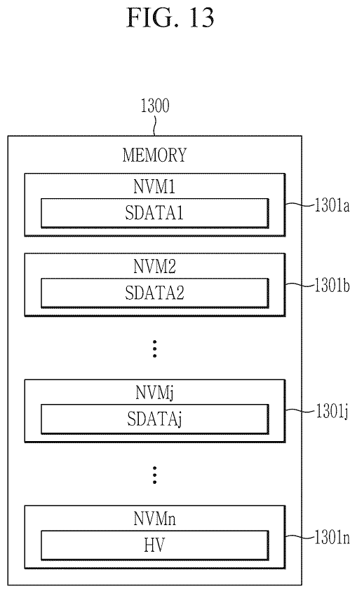

Referring to FIG. 13, a plurality of pieces of encoding data SDATA1 to SDATAj and a hash value HV stored in a memory will be described.

FIG. 13 is a block diagram of a nonvolatile memory of a storage device according to some example embodiments.

Referring to FIG. 13, a nonvolatile memory device 1300 may include a plurality of memories 1301a to 1301n. A flash interface may distribute and store a plurality of pieces of encoding data SDATA1 to SDATAj to a plurality of memories 1301a to 1301n. For example, each of the plurality of memories 1301a to 1301j may store a corresponding one of the plurality of pieces of encoding data SDATA1 to SDATAj.

The flash interface may store the hash value HV in one memory 1301n of the plurality of memories 1301a to 1301n. In some example embodiments, the flash interface may store the hash value HV in a secure area of the memory 1301n.

Since the storage device according to some example embodiments stores a plurality of pieces of encoding data SDATA1 to SDATAj and a hash value HV in different memories NVM1, NVM2, NVMj, and NVMn, the risk of falsification of the entire original data is reduced.

In the storage device according to some example embodiments, since the hash value HV is stored in the secure area, even if the scrambled data SDATA are falsified, the falsified scrambled data SDATA are descrambled with the hash value HV, and thus it is possible to check whether data are falsified using the descrambled data RDATA.

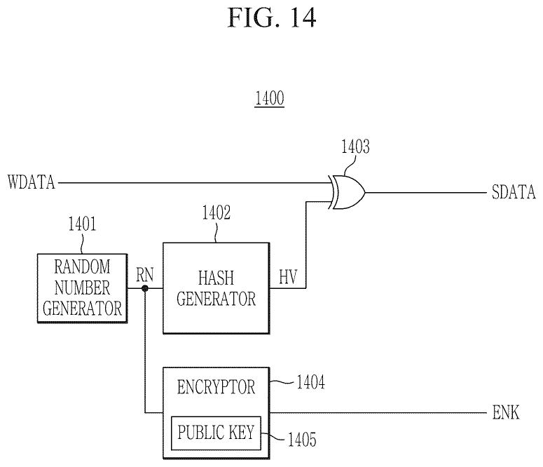

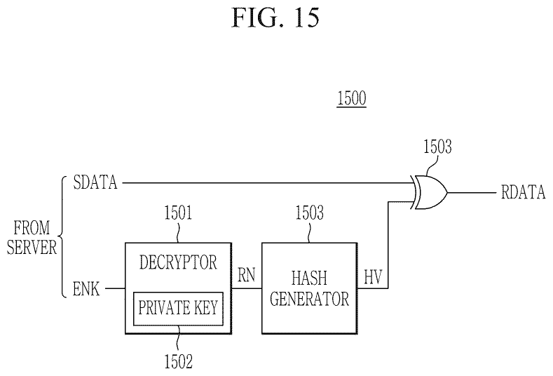

Next, referring to FIG. 14 and FIG. 15, protect modules of storage devices of a client and a server will be described.

FIG. 14 is a block diagram of a protect module of a server according to some example embodiments, and FIG. 15 is a protect module of a client according to some example embodiments.

Referring to FIG. 14, a protect module 1400 of a server may receive input data WDATA from a client. The protect module 1400 of the server may scramble input data WDATA and store it in a memory. The protect module 1400 of the server may transmit the scrambled data SDATA read from the memory to the client that transmitted the input data WDATA.

The protect module 1400 of the server may include a random number generator 1401, a hash generator 1402, an XOR gate 1403, and an encryptor 1404. Description of the same or similar operations to the random number generator 501, the hash generator 502, the XOR gate 503, and the encoding-decoding circuit 504 of FIG. 5 will be omitted.

The random number generator 1401 may generate a random number RN.

The hash generator 1402 may output a hash value HV using a hash algorithm. The hash generator 1402 may generate the hash value HV using a random number RN.

The XOR gate 1403 may generate scrambled data SDATA using input data WDATA and the hash value HV. The XOR gate 1403 may output the scrambled data SDATA to a flash interface to store the scrambled data SDATA in a memory. The scrambled data SDATA may be stored in the memory through the flash interface.

The encryptor 1404 may generate an encryption key ENK by encrypting the random number RN. The encryptor 1404 may encrypt the random number RN using a public key 1405 of the client. The encryptor 1404 may output the encryption key ENK to the flash interface to store the encryption key ENK in the memory. In this case, the encryption key ENK and the scrambled data SDATA may be stored in association with each other in the memory.

Referring to FIG. 15, the protect module 1500 of the client may receive scrambled data SDATA from the server. The protect module 1500 of the client may be positioned in the storage device of the client. The protect module 1500 of the client may descramble the scrambled data SDATA and store it in the memory.

The protect module 1500 of the client may include a decryptor 1501, a hash generator 1503, and an XOR gate 1504. The description of the same or similar operations to the hash generator 502 and the XOR gate 505 of FIG. 5 will be omitted.

The decryptor 1501 may output a random number RN by decrypting the encryption key ENK. The decryptor 1501 may decrypt the encryption key ENK using a private key 1502 of the client. The decryptor 1501 may output a random number RN to the hash generator 1503.

The hash generator 1503 may output the hash value HV using a hash algorithm. The hash generator 1503 may generate a hash value HV using a random number RN.

The XOR gate 1504 may generate descrambled data RDATA using scrambled data SDATA and the hash value HV received from the server.

In the storage system according to some example embodiments, the hash value HV is encrypted with the public key of the client and decrypted with the private key of the client, and thus it is possible to prevent or reduce data leakage of the client, and even if the scrambled data SDATA are falsified, the falsified scrambled data SDATA can be hashed and are descrambled with the value HV, and thus it is possible to be determined whether data are falsified using the descrambled data RDATA.

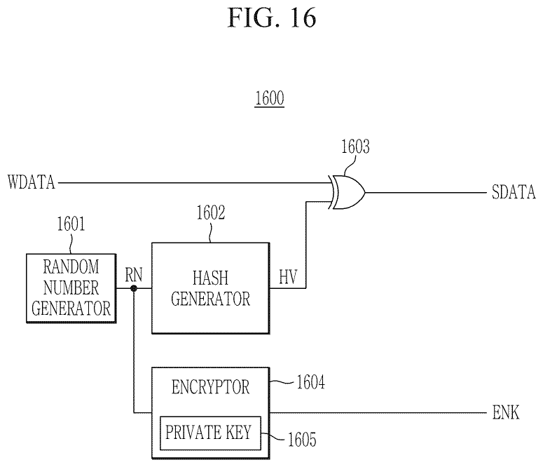

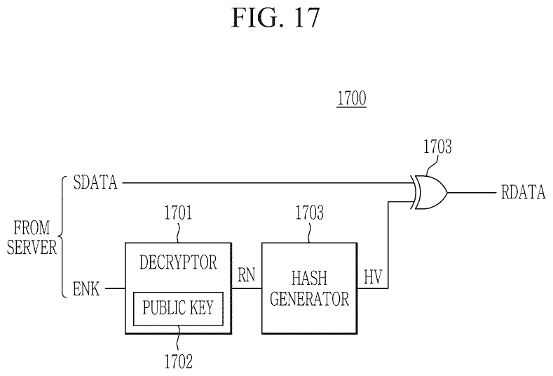

FIG. 16 is a block diagram of a protect module of a server according to some example embodiments, and FIG. 17 is a block diagram of a protect module of a client according to some example embodiments.

Referring to FIG. 16, a protect module 1600 of a server may include a random number generator 1601, a hash generator 1602, an XOR gate 1603, and an encryptor 1604. Descriptions of the same or similar operations to the random number generator 1401, the hash generator 1402, the XOR gate 1403, and the encryptor 1404 of FIG. 14 will be omitted.

A random number generator 1601 may generate a random number RN.

The hash generator 1602 may output a hash value HV using a hash algorithm. The hash generator 1602 may generate a hash value HV using a random number RN.

The XOR gate 1603 may generate scrambled data SDATA using input data WDATA and the hash value HV. The XOR gate 1603 may output the scrambled data SDATA to a flash interface to store the scrambled data SDATA in a memory. The scrambled data SDATA may be stored in the memory through the flash interface.

The encryptor 1604 may generate an encryption key ENK by encrypting the random number RN. The encryptor 1604 may encrypt the random number RN using the private key 1605 of the server. The encryptor 1604 may output the encryption key ENK to the flash interface to store the encryption key ENK in the memory. In this case, the encryption key ENK and the scrambled data SDATA may be stored in association with each other in the memory.

Referring to FIG. 17, a protect module 1700 of a client may include a decryptor 1701, a hash generator 1703, and an XOR gate 1704. Descriptions of the same or similar operations to the decryptor 1501, the hash generator 1503, and the XOR gate 1504 of FIG. 15 will be omitted.

The decryptor 1701 may output a random number RN by decrypting an encryption key ENK. The decryptor 1701 may decrypt the encryption key ENK using a public key 1702 of a server. The decryptor 1701 may output the random number RN to the hash generator 1703.

The hash generator 1703 may output the hash value HV using the hash algorithm. The hash generator 1703 may generate the hash value HV using the random number RN.

The XOR gate 1704 may generate descrambled data RDATA using the scrambled data SDATA and the hash value HV received from the server.

In the storage system according to some example embodiments, since the hash value HV is encrypted with the private key of the server and decrypted with the public key of the server, it is possible to prevent or reduce data leakage by providing the server's public key to a specific client, even if the scrambled data SDATA is falsified, since the falsified scrambled data SDATA is descrambled with the hash value HV, it is possible to check whether data is falsified using the descrambled data RDATA.

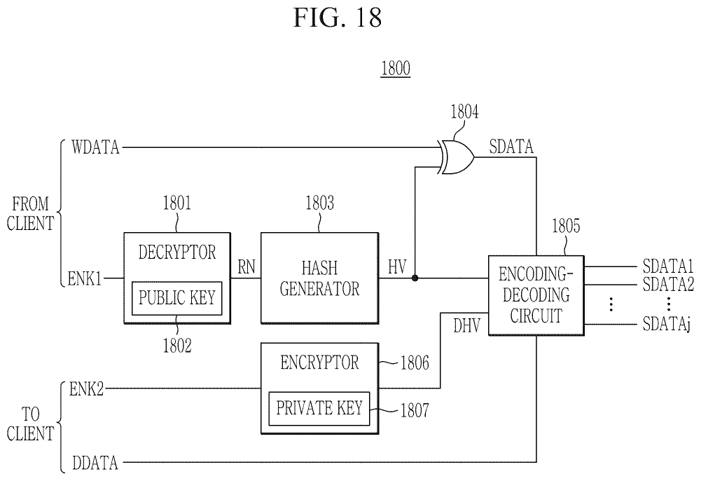

FIG. 18 is a block diagram of a protect module of a server according to some example embodiments.

Referring to FIG. 18, a protect module 1800 of a server may receive input data WDATA and an encryption key ENK1 from a client. The protect module 1800 of the server may scramble and encode the input data WDATA and store it in a memory. The protect module 1800 of the server may decode the encoding data SDATA1 to SDATAj read from the memory and transmit it to the client that has transmitted the input data WDATA.

The protect module 1800 of the server may include a decryptor 1801, a hash generator 1803, an XOR gate 1804, an encoding-decoding circuit 1805, and an encryptor 1806.

The decryptor 1801 may decrypt the encryption key ENK1 received from the client and output a random number RN. In some example embodiments, the decryptor 1801 may use a public key 1802 of the client to decrypt the encryption key ENK1. The decryptor 1801 may output a random number RN to the hash generator 1803. In some example embodiments, the decryptor 1801 may decrypt the encryption key ENK1 using the private key of the server. The decryptor 1801 may output the random number RN to the hash generator 1803.

The hash generator 1803 may output the hash value HV using the hash algorithm. The hash generator 1803 may generate a hash value HV using a random number RN.

The XOR gate 1804 may generate scrambled data SDATA using the input data WDATA and the hash value HV.

The encoding-decoding circuit 1805 may encode the scrambled data SDATA and the hash value HV into a plurality of pieces of encoding data SDATA1 to SDATAj. The encoding-decoding circuit 1805 may output a plurality of pieces of encoding data SDATA1 to SDATAj to the flash interface.

The encoding-decoding circuit 1805 may decode the plurality of pieces of encoding data SDATA1 to SDATAj to generate decoded data DDATA and a decoded hash value DHV.

The encryptor 1806 may generate an encryption key ENK2 by encrypting the decoded hash value DHV. In some example embodiments, the encryptor 1806 may encrypt the decoded hash value DHV using a private key 1807 of the server. In some example embodiments, the encryptor 1806 may encrypt the decoded hash value DHV using a public key 1802 of the client.

The server may transmit the decoded data DDATA and the encryption key ENK2 to the client. The server may transmit the decrypted data DDATA and the encryption key ENK2 to the client that has transmitted the encrypted hash value encryption key ENK1 and the input data WDATA to the server.

Since a storage system according to some example embodiments scrambles the input data WDATA using the random number RN decrypted with the public key of the client, it can be determined that the input data WDATA are transmitted from the client. In addition, since the decoding hash value DHV is encrypted with the public key of the client, leakage to clients other than the corresponding client can be prevented or reduced.

A storage system according to some example embodiments provides a specific client with a public key of a client, and thus the encryption key ENK1 encrypted with a public key of the server is decrypted with a private key of the server such that a random number RN is output, and the output random number RN is used to generate a hash value HV. Therefore, data can be received only from the client authenticated by the server. In addition, data leakage can be prevented or reduced by encrypting the decoding hash value DHV with the private key of the server and providing the public key of the server to a specific client.

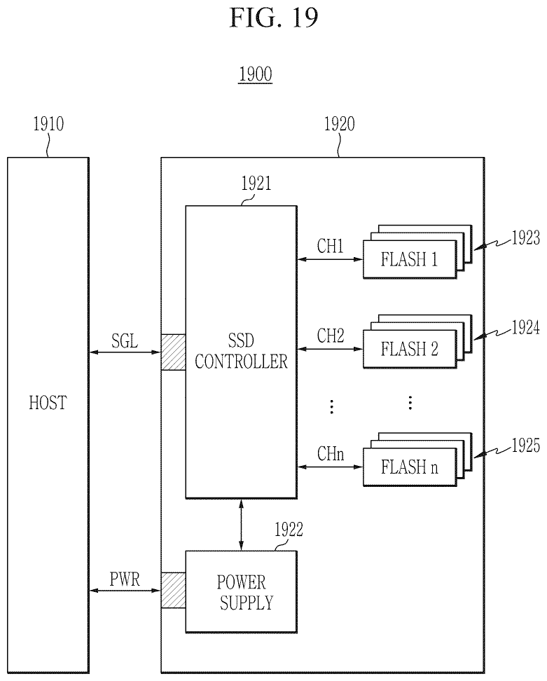

FIG. 19 is a block diagram of an example of application of the storage device according to some example embodiments to a solid-state drive (SSD).

Referring to FIG. 19, an SSD system 1900 may include a host 1910 and an SSD 1920.

The SSD 1920 may be implemented using some example embodiments described with reference to in FIG. 1 to FIG. 18. The SSD 1920 may transmit and receive signals to and from the host 1910 through a signal connector (SGL), and may receive power through a power connector (PWR).

The SSD 1920 may receive a firmware image download command and a firmware image to be downloaded through the signal connector SGL.

The SSD 1920 may include a controller 1921, an auxiliary power supply unit 1922, and a plurality of memory systems 1923, 1924, and 1925. Each of a plurality of memory systems 1923, 1924, and 1925 may include at least one flash memory device as a storage device. In addition, each flash memory device may include at least one die DIE, and at least one block may be disposed to each die DIE.

The controller 1921 may communicate with a plurality of memory systems 1923, 1924, and 1925 through a plurality of channels Ch1 to Chn. The controller 1921 may generate a hash value, scramble the data using the hash value, and store it in the plurality of memory systems 1923, 1924, and 1925. The controller 1921 may read and decode data stored in the plurality of memory systems 1923, 1924, and 1925, and descramble the decoded hash value and the decoded data.

Conventional devices for performing alteration detection in image data (or video data, etc.) by analyzing data obtained by encoded an image and metadata relating to the image data. As such, excessive consumption of processing resources, in particular security overhead resources (e.g., processor, power, delay, etc.) may be used resulting in higher memory costs and/or lower throughput due to dropped packets/data encoding.

However, example embodiments describe improved methods and devices for performing alteration detection in which the image/video data undergoes an XOR operation with a has value to generate modulated video data, while storing the modulated video data and hash value in metadata format as discussed above to easily (e.g., using less processing power) detect falsified data. Thus, the improved methods and devices reduce consumption of security overhead resources (e.g., processor, power, delay, etc.), and/or reduce memory costs and improving throughout by reducing the amount of processing power and amount of data to be processed by the CPU 211.

It will be understood that some or all of any of the devices, controllers, generators, decoders, units, modules, circuits, processors, or the like according to any of the example embodiments as described herein, including some or all of storage system 100, clients 110a to 110h, etc., server 120, host 121, storage device 122 (200, etc.), storage controller 123 (210, etc.), memory 124 (220, etc.), CPU 211, protect module 212, RAM 213, host interface 214, buffer manager 215, flash interface 217, random number generator 501 (1001, etc.), hash generator 502 (1002, etc.), encoding-decoding circuit 504 (801, etc.), encryptor 1404, decryptor 1501, SSD system 1900, and their respective sub elements shown, any combination thereof, or the like may be included in, may include, and/or may be implemented by one or more instances of processing circuitry such as hardware including logic circuits, a hardware/software combination such as a processor executing software; or a combination thereof. In some example embodiments, said one or more instances of processing circuitry may include, but are not limited to, a central processing unit (CPU), an application processor (AP), an arithmetic logic unit (ALU), a graphic processing unit (GPU), a digital signal processor, a microcomputer, a field programmable gate array (FPGA), a System-on-Chip (SoC) a programmable logic unit, a microprocessor, or an application-specific integrated circuit (ASIC), etc. In some example embodiments, any of the memories, memory units, or the like as described herein may include a non-transitory computer readable storage device, for example a solid state drive (SSD), storing a program of instructions, and the one or more instances of processing circuitry may be configured to execute the program of instructions to implement the functionality of some or all of any of the devices, controllers, decoders, units, modules, or the like according to any of the example embodiments as described herein, including any of the methods of operating any of same as described herein.

Although the figures illustrate circuit elements as being distinct, example embodiments are not limited thereto, and some of the functions of circuit elements and units may be performed by other circuit elements and units. This may also be the case of additional elements within the example embodiments as described in example embodiments herein.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

What is claimed is:

1. A storage device comprising:
a memory; and
a storage controller configured to
generate a hash value,
generate scrambled data by scrambling input data with the hash value, and
store the scrambled data and the hash value in association with each other in the memory.

2. The storage device of claim 1, wherein the storage controller is configured to generate the has value by applying a hash algorithm to an output value or input data of a random number generator.

3. The storage device of claim 1, wherein the storage controller is configured to generate scrambled data by performing an XOR operation on the input data and the hash value.

4. The storage device of claim 1, wherein
the storage controller is configured to
apply a hash algorithm to the hash value at least once to generate at least one additional hash value, and
generate the scrambled data by performing XOR operation on the input data, the hash value, and the at least one additional hash value.

5. The storage device of claim 1, wherein
the memory comprises a plurality of nonvolatile memories,
the storage controller is configured to
encode the scrambled data and the hash value into a plurality of pieces of encoded data and
distribute and store the plurality of pieces of the encoded data in the plurality of nonvolatile memories, and
each of the plurality of pieces of encoded data comprises a part of the scrambled data and a part of the hash value.

6. The storage device of claim 5, wherein
each of the plurality of nonvolatile memories comprises a plurality of pages including a main area and a spare area, and
the storage controller is configured to
store the part of the scrambled data in the main area, and
store the part of the hash value in the spare area.

7. The storage device of claim 5, wherein
the storage controller is configured to
read the plurality of pieces of the encoded data from the plurality of nonvolatile memories,
decode the plurality of pieces of the encoded data into the scrambled data and the hash value, and
generate descrambled data by descrambling the decoded scrambled data and the decoded hash value.

8. The storage device of claim 5, wherein
the storage controller is configured to
read the plurality of pieces of the encoded data from the plurality of nonvolatile memories,
decode the plurality of pieces of the encoded data into the scrambled data and the hash value,
generate an encryption key by encrypting the decoded hash value with a private key of a server including the storage device, and
transmit the decoded scrambled data and the encryption key to an external client.

9. The storage device of claim 1, wherein
the memory comprises a plurality of nonvolatile memories, and
the storage controller is configured to
encode the scrambled data into a plurality of pieces of encoded data, and
distribute and store the plurality of pieces of encoded data and the hash value in the plurality of nonvolatile memories.

10. The storage device of claim 9, wherein:
the storage controller is configured to
read the plurality of pieces of the encoded data and the hash value from the plurality of nonvolatile memories,
decode the plurality of pieces of the encoded data into the scrambled data, and
generate descrambled data by descrambling the decoded scrambled data and the hash value read from the plurality of nonvolatile memories.

11. The storage device of claim 1, wherein
the memory comprises a secure area, and
the storage controller is configured to store the hash value in the secure area.

12. The storage device of claim 1, wherein
the storage controller is configured to
generate descrambled data by descrambling the scrambled data and the hash value, and
determine whether the descrambled data are falsified.

13. The storage device of claim 1, wherein:
the storage controller is configured to
receive input data and a public key of a client from an external client,
generate the hash value using an output value of a random number generator,
encrypt the hash value with the public key of the client to generate an encryption key, and
store the scrambled data and encryption key in association with each other in the memory.

14. The storage device of claim 1, wherein:
the storage controller is configured to
generate the hash value using an output value of a random number generator,
encrypt the output value of the random number generator with a private key of a server including the storage device to generate an encryption key, and
store scrambled data and encryption key in association with each other in the memory.

15. The storage device of claim 1, wherein:
the storage controller is configured to
receive the input data, a first encryption key, and a public key of a client from an external client, and
generate the hash value by using a decrypted value of the encryption key as the public key of the client.

16. A data processing method comprising:
receiving input data;
generating a hash value;
generating scrambled data by scrambling the input data with the hash value; and
storing the scrambled data with the hash value in association with each other in a memory.

17. The data processing method of claim 16, further comprising:
reading scrambled data and the hash value from the memory;
generating descrambled data by descrambling the scrambled data read from the memory and the hash value read from the memory; and
determining whether the descrambled data has been falsified.

18. A storage system comprising:
at least one client; and
a server configured to
receive contents data from a first client among the at least one client,
generate a hash value,
generate scrambled data by scrambling the contents data with the hash value, and
store an encrypted key encrypted from the hash value and the scrambled data in association with each other in a memory.

19. The storage system of claim 18, wherein:
The server is further configured to
receive a public key of the first client from the first client,
generate the encryption key by encrypting the hash value as the public key of the first client, and
transmit the scrambled data and the encryption key read from the memory to the first client.

20. The storage system of claim 18, wherein:
the server is configured to
generate the encryption key by encrypting the hash value as a private key of the server, and
transmit the scrambled data read from the memory, the encryption key, and a public key of the server to the first client.
